(19) United States
(12) Patent Application Publication
(10) Pub. No.: US 2023/0166463 A1
(43) Pub. Date: Jun. 1, 2023

(54) A LIQUID-IMPERMEABLE AIR DIFFUSER USED FOR PRODUCING POLYMERIC COMPOSITE MATERIALS

(71) Applicant: TELATEKS TEKSTIL ÜRÜNLERI SAN. VE TIC. A.S., Tuzla, Istanbul (TR)

(72) Inventor: Gülnur BASER, Tuzla, Istanbul (TR)

(21) Appl. No.: 17/995,786

(22) PCT Filed: Dec. 16, 2021
(86) PCT No.: PCT/TR2021/051431

§ 371 Date: Oct. 7, 2022

(30) Foreign Application Priority Data
Dec. 17, 2020 (TR) 2020/20804

(51) Int. Cl. B29C 70/54; B29C 70/44; B32B 5/02; B32B 27/12

(52) U.S. Cl. CPC B29C 70/544; B29C 70/443; B32B 5/022; B32B 5/024; B32B 5/026; B32B 27/12; B32B 2307/724; B32B 2307/7265

(57) ABSTRACT

Disclosed is a liquid-impermeable air diffuser developed for use in vacuum assisted infusion methods, which are the methods for producing the fiber-reinforced polymeric composite materials for sectors such as energy, wind turbine, transportation, automotive, marine, defense, aerospace, urban goods, water slides, and sports equipment (ski, snowboard, surfing, etc.).

### TECHNICAL FIELD

The invention relates to a liquid-impermeable air diffuser developed for use in the vacuum assisted infusion methods, which are the methods for producing the fiber-reinforced polymeric composite materials for the sectors such as energy, wind turbine, transportation, automotive, marine, defense, aerospace, urban goods, water slides, sports equipment (ski, snowboard, surfing, etc.).

### PRIOR ART

In the state of the art, fiber-reinforced polymeric composite materials are produced by the vacuum-assisted infusion methods. For the composition of the parts, fiber reinforcements (for example, in the forms of a fabric, multidirectional textiles, a felt, a chopped fiber mat, non-woven fabrics, etc.) such as glass, carbon, aramid etc., and matrix materials (thermosetting resins or thermoplastic resins such as liquid epoxy, polyester, vinyl ester) are used. The fiber reinforcement is placed on a mould. It is compressed with an air pressure by being sealed and vacuumed across the perimeter thereof so as to be air-tight by placing an air- and liquid-impermeable film thereon. The matrix material is penetrated into the fiber by being sucked via a vacuum through an inlet located under the film. The matrix material wets the fiber completely, and the matrix material solidifies after a certain period of time. Prior to solidifying, it is necessary for all the resins to be penetrated into the fiber. In the case that the matrix solidifies before the fiber is completely wet, the part becomes unusable. The air bubbles are formed in the resin during the penetration of the resin into the fiber. If the air bubbles remain in the matrix, the mechanical strength of the part is reduced. During the penetration of the matrix material, the air circulating in the fiber should be evenly distributed everywhere, and the air bubbles should be removed from the resin. In order to accelerate the matrix flow and to eliminate the air bubbles, breathable porous materials should be used, such as a net, a felt, etc. These materials, on the other hand, substantially enclose the matrix therein by drawing it inwardly, and the desired ratio of the fiber/matrix in the production of the part cannot be obtained.

The flow regulators of the state of the art enclose the matrix material therein by absorbing the same and affect the ratio of the fiber/matrix of said material. Therefore, a substantial amount of matrix material is wasted.

There is a need to develop new systems which do not fall within the state of the art and will prevent said disadvantages.

### SUMMARY OF THE INVENTION

The object of this invention is to achieve the production of the parts of good quality by way of an infusion method which is the method for producing a vacuum assisted fiber-reinforced polymeric composite material.

Another object of the invention is to enable the penetration of the matrix into the fiber in a sufficient time by accelerating the flow of the matrix material, the elimination of the undesired air bubbles from the matrix material (for example, from the resin) and distributing the matrix evenly to the entire resin by diffusing the air finely.

In one embodiment, another object of the invention is to make one surface of the polymeric composite material rough and to increase the adhesion capacity of the surface during adhering to another part by virtue of the formed rough surface.

### DESCRIPTION OF THE DRAWINGS

FIG. 1 is a representative view of an embodiment of the method for obtaining a composite material of the invention.

FIG. 2 is a representative view of another embodiment of the method for obtaining a composite material of the invention.

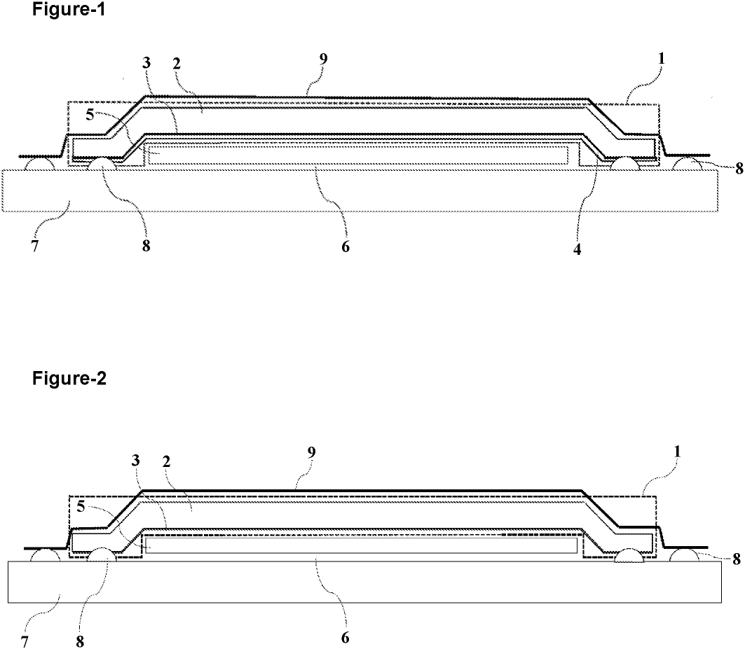

### DESCRIPTION OF THE REFERENCES IN THE DRAWINGS

The numbers in the drawings are provided below in order to provide a better understanding of the invention:
1. Liquid-impermeable air diffuser
2. First layer
3. Second layer
4. Third layer
5. Fiber reinforcement
6. Matrix material
7. Mould
8. Sealing tape
9. Bagging film

### DETAILED DESCRIPTION OF THE INVENTION

In one embodiment, the liquid-impermeable air diffuser (1) of the invention comprises a first layer (2) comprising a textile material which has a large porous air permeability such as knits/fabrics woven from natural fibers and/or from synthetic fibers and/or from inorganic fibers, and/or non-woven fabrics, a felt, a chopped mat and the like, is voluminous and has a thickness in the order of millimeters, as well as being able to diffuse the air evenly, a second layer (3) comprising a micro-porous film and/or a surface which is liquid-impermeable in the water-like viscosities, but which is air-permeable, and a third impression forming layer (4) comprising a removable knit/woven and/or fabric woven from synthetic fibers and/or from inorganic fibers.

The liquid-impermeable air diffuser (1) of the invention is used during the production of a polymeric composite material by an infusion method in a mould (7). In addition, in order to be able to carry out the vacuum (infusion), materials such as a valve (not shown and numbered in the figures), a mould release agent (not shown and numbered in the figures), a sealing tape (8), a bagging film (9) and a flow aid (not shown and numbered in the figures) are used for the production of said composite materials.

The second layer (3) is combined with the third layer (4) which is a porous, rough and removable layer, and it is ensured that the third layer (3) provides impressions on the matrix material (6). By virtue of said roughness feature, it is ensured that the surface adhesion capacity is increased in the subsequent part adhering processes.

The liquid-impermeable air diffuser of the invention (1) does not absorb and enclose the matrix material (6), since it is air-permeable and liquid-impermeable. The ratio of matrix material (6) is increased with said liquid-impermeable air diffuser (1). In other words, it may contain 25% or more by weight of the matrix material (6). Thus, the formation of a polymeric composite material of desired quality in the desired ratio of fiber/matrix is ensured, which does not contain any air bubble.

After the composite material is produced, a mould release agent (not shown and numbered in the figures) on the mould (7) serves to separate said composite material for demoulding. Any leakage in the vacuum system is prevented by means of the sealing tape (8). It is ensured that the vacuum system is protected from the external factors during the production of the composite material thanks to the bagging film (9) which is capable of resisting to the high temperature and contacting the matrix material (6), and which has the air tightness.

The matrix material (6) contained in the said composite material is a resin, wherein resins such as unsaturated polyester resin, vinyl ester resin, epoxy-based resin, etc. can be used.

There is a flow aid (not shown and numbered in the figures) in the infusion system to ensure the interior flow to be performed with no problem while vacuuming. In one preferred embodiment of the invention, said flow aid (not shown and numbered in the figures) is a vacuum pump.

Since the air permeability of the liquid-impermeable air diffuser (1) of the invention is high, it ensures that the air pressure applied by the vacuum (not shown and numbered in the figures) is diffused evenly in the surface and the layers of the entire fiber reinforcement (5) and the matrix material (6) is absorbed evenly and quickly. Furthermore, the second layer (3) and the matrix material (6) do not react in any chemical way. The liquid-impermeable air diffuser (1) of the invention ensures that the air in the form of bubble enclosed inside the matrix material (6) is removed. In other ways, the formation of the air bubbles is avoided. Since the surface of the liquid-impermeable air diffuser (1), which faces the matrix material (6) is liquid-impermeable, it does not absorb the matrix material (6), and the matrix material (6) is diffused evenly in the fiber reinforcement (5). The desired fiber/matrix ratio is obtained by having 25% or more by weight matrix material (6). In addition, the third impression forming layer (4) contained in the liquid-impermeable air diffuser (1) ensures the desired roughness on the part to be obtained.

In another embodiment of the invention, said liquid-impermeable air diffuser (1) comprises two main layers. The first layer (2) is the air diffusing layer, wherein it comprises a textile material which has a large porous air permeability such as knits/fabrics woven from natural fibers and/or from synthetic fibers and/or from inorganic fibers, and/or non-woven fabrics, a felt, a chopped mat and the like, is voluminous and has a thickness in the order of millimeters. The second layer (3) is the liquid-impermeable and air-permeable layer, wherein it comprises a micro-porous plastic film or plastic surface which is liquid-impermeable in the water-like viscosities and is air-permeable. In said embodiment, only the third layer (4) is not included, and it differs from the first embodiment only in this aspect.

### INDUSTRIAL APPLICABILITY OF THE INVENTION

The liquid-impermeable air diffuser (1) of the invention is applied industrially for use in an infusion method which is used in the production of composite material for the sectors such as energy, wind turbine, transportation, automotive, marine, defense, aerospace, urban goods, water slides, sports equipment (ski, snowboard, surfing, etc.).

The invention is not limited to the above descriptions, and a person skilled in the art can easily reveal the different embodiments of the invention. These should be considered within the scope of protection of the invention claimed in the claims.

1. A liquid-impermeable air diffuser for use in an infusion method which is used in the production of a composite material for sectors such as energy, wind turbine, transportation, automotive, marine, defense, aerospace, urban goods, water slides, sports equipment (ski, snowboard, surfing, etc.), the liquid-impermeable air diffuser comprising a first layer comprising a textile material which has a large porous air permeability such as knits/fabrics woven from natural fibers and/or from synthetic fibers and/or from inorganic fibers, and/or non-woven fabrics, a felt, a chopped mat and the like, is voluminous and has a thickness in the order of millimeters, as well as being able to diffuse the air evenly, and a second layer comprising a micro-porous plastic film and/or a plastic surface, which is liquid-impermeable in the waterlike viscosities, but is air-permeable, and a third impression forming layer comprising a removable knit and/or fabric woven from synthetic fibers and/or from inorganic fibers.

2. A liquid-impermeable air diffuser for use in an infusion method which is used in the production of composite material for sectors such as energy, wind turbine, transportation, automotive, marine, defense, aerospace, urban goods, water slides, sports equipment (ski, snowboard, surfing, etc.); the liquid-impermeable air diffuser comprising a first layer comprising a textile material which has a large porous air permeability such as knits/fabrics woven from natural fibers and/or from synthetic fibers and/or from inorganic fibers, and/or non-woven fabrics, a felt, a chopped mat and the like, is voluminous and has a thickness in the order of millimeters, as well as being able to diffuse the air evenly, and and a second layer comprising a micro-porous plastic film and/or a plastic surface, which is liquid-impermeable in the waterlike viscosities, but is air-permeable.

3. A liquid-impermeable air diffuser according to claim 1, wherein the second layer does not absorb and enclose the matrix material.

4. A liquid-impermeable air diffuser according to the claim 1, wherein the third impression forming layer is porous, rough and removable and increases the adhesiveness.

5. A liquid-impermeable air diffuser according to claim 1, wherein it is used in the production of a polymeric composite material and the produced polymeric composite material comprises 25% and more by weight of the matrix material.
